(19) United States
(12) Patent Application Publication
(10) Pub. No.: US 2015/0040528 A1
(43) Pub. Date: Feb. 12, 2015

(54) RESIDUE MANAGEMENT SYSTEM FOR AN AGRICULTURAL VEHICLE

(71) Applicant: CNH America LLC, New Holland, PA (US)

(72) Inventors: Nathan C. Grotelueschen, Spicer, MN (US); Lyle P. Mangen, Willmar, MN (US); Edward H. Priepke, Lancaster, PA (US); Christopher A. Foster, Lititz, PA (US); John H. Posselius, Ephrata, PA (US)

(73) Assignee: CNH America LLC, New Holland, PA (US)

(21) Appl. No.: 13/960,157

(22) Filed: Aug. 6, 2013

(51) Int. Cl. A01D 46/08

(52) U.S. Cl. CPC A01D 46/08
USPC 56/10.1; 56/29

(57) ABSTRACT

Residue management systems for an agricultural vehicle include a managing assembly configured to manage agricultural residue. The managing assembly includes a rotating member configured to rotate about a shaft that extends along a lateral axis of the agricultural vehicle relative to the direction of travel a frame configured to support the managing assembly. The managing assembly also includes a support arm coupled to the frame and configured to pivotally couple to a support structure of the agricultural vehicle proximate to a rear end of the agricultural vehicle relative to the direction of travel. The support arm is configured to facilitate movement of the managing assembly between a lowered operational position and a raised transport position.

### BACKGROUND

The present invention relates generally to a residue management system for an agricultural vehicle.

It may be desirable to manage (e.g., shred, chop, etc.) residual material that remains after an agricultural product has been harvested from a field to prepare the field for subsequent use or processes. For example, an area of a prepared field may be managed for use as a pad on which harvested product may be unloaded from a harvester. Additionally, a prepared field may be managed for other agricultural operations (e.g., planting, seeding, tilling). Currently, harvesting the agricultural product and managing the residual material are often performed in separate operations. These separate operations generally utilize significant resources such as separate equipment, additional time, and/or additional labor to complete. As a result, the cost associated with performing these operations may be undesirably high.

### BRIEF DESCRIPTION

In a first embodiment, a residue management system for an agricultural vehicle includes a managing assembly configured to manage agricultural residue. The managing assembly includes a rotating member configured to rotate about a shaft that extends along a lateral axis of the agricultural vehicle relative to the direction of travel a frame configured to support the managing assembly. The managing assembly also includes a support arm coupled to the frame and configured to pivotally couple to a support structure of the agricultural vehicle proximate to a rear end of the agricultural vehicle relative to the direction of travel. The support arm is configured to facilitate movement of the managing assembly between a lowered operational position and a raised transport position.

In a second embodiment, a residue management system for an agricultural vehicle includes a managing assembly disposed on a toolbar proximate to a first end of the agricultural vehicle. The toolbar is configured to support a harvesting element, the managing assembly is configured to manage agricultural residue, and the managing assembly includes a vertical rotating member configured to rotate about a shaft that extends along a vertical axis.

In a third embodiment, an agricultural vehicle includes a harvesting element coupled to a first toolbar proximate to a front end of the agricultural vehicle and a residue management system having a managing assembly disposed on a second toolbar positioned behind the first toolbar relative to a direction of travel. The managing assembly is configured to manage agricultural residue.

### DRAWINGS

These and other features, aspects, and advantages of the present invention will become better understood when the following detailed description is read with reference to the accompanying drawings in which like characters represent like parts throughout the drawings, wherein:

FIG. 1 is a side view of an embodiment of a harvesting vehicle including a residue management system;

FIG. 2 is a side view of an embodiment of a residue management system of the harvesting vehicle of FIG. 1 in a lowered operational position;

FIG. 3 is a side view of the residue management system of FIG. 2 in a raised transport position;

FIG. 4 is a top view of the residue management system of FIG. 2;

FIGS. 5A-5D are perspective views of respective embodiments of managing assemblies that may be employed within the residue management system of FIG. 2;

FIG. 6 is a side view of an embodiment of a harvesting element and an embodiment of a residue management system;

FIG. 7 is a top view of an embodiment of a harvesting element of a cotton harvester with an alternative embodiment of a residue management system FIG. 6; and

FIG. 8 is a side view of an embodiment of a harvesting element and an embodiment of a residue management system on a separate toolbar.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The techniques described herein relate to residue management systems for agricultural vehicles. In order to increase efficiency and combine harvesting and residue management operations, an embodiment of a residue management system for an agricultural vehicle includes a managing assembly coupled to a rear end (e.g., a rear bumper) of the vehicle. The managing assembly includes a rotating member configured to rotate about a lateral axis to chop, compress, and/or otherwise manage agricultural residue. Thus, the rotating member may include a variety of elements such as a roller with ribs, a flail cutter, and a disc harrow, among others. The rotating member may be powered (e.g., the flail cutter), or may be driven by contact with the ground. For flexibility, the managing assembly may be raised and placed in a transports position or lowered into an operational position. In certain embodiments, the managing system is supported by a support arm with a pivoting joint structure configured to facilitate vertical movement of the managing element. Additionally, an actuating cylinder may be included to assist in driving the managing assembly between the lowered and raised positions.

Furthermore, harvesting vehicles may have harvesting elements disposed on the front of the vehicle (e.g., on toolbars that can raise and lower the harvesting elements). Certain disclosed embodiments include managing assemblies disposed on the toolbar with the harvesting elements. In these embodiments, the managing assemblies may be disposed directly behind rotors of the harvesting elements (e.g., in the same housing as the harvesting elements). Alternatively, the managing assemblies may be disposed in separate housings (e.g., behind the harvesting elements). This configuration may enable simplified access to the separate elements for inspection or maintenence. It may be beneficial to separately control managing assemblies and harvesting elements. Accordingly, disclosed embodiments include managing assemblies disposed on a separate toolbar on the front of the agricultural vehicle.

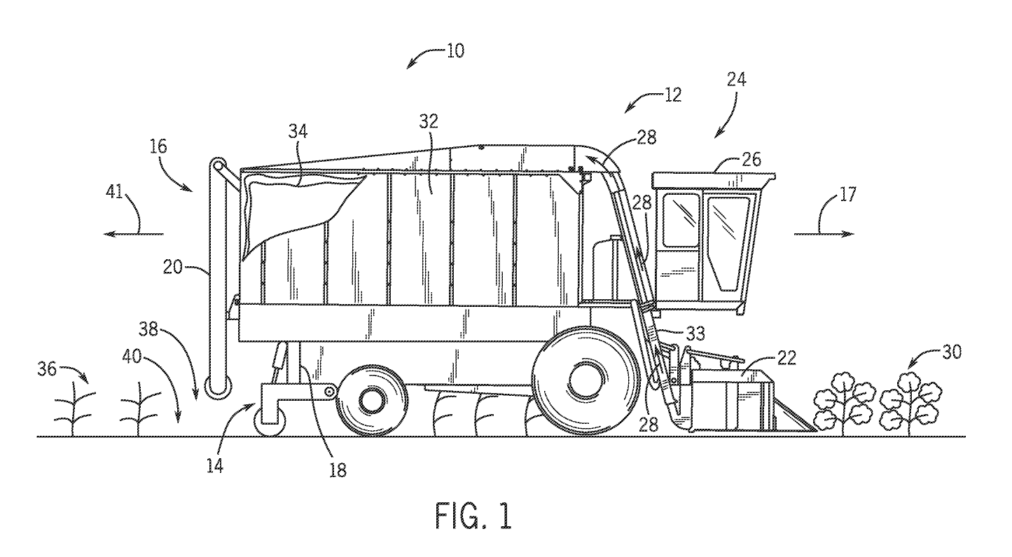

Turning now to the figures, FIG. 1 is a side view of an embodiment of a harvesting system 10 including a harvesting vehicle 12 and residue management system 14. In the illustrated embodiment, the harvesting vehicle 12 is a self-propelled vehicle. Alternatively, the harvesting vehicle 12 may be propelled by another vehicle. For example, in certain embodiments the harvesting vehicle 12 may be towed behind or alongside a tow vehicle such as a tractor. As illustrated, the residue management system 14 is positioned proximate to a rear end 16 of the vehicle 12 relative to a direction of travel 17. In the illustrated embodiment, the residue management system 14 is coupled to a rear bumper 18 that extends laterally across the rear end 16 of the vehicle 12. However, in alternative embodiments, the residue management system 14 may be coupled to other support structures of the vehicle 12 that are proximate to the rear end 16. In some embodiments and as pictured, an unloading ramp 20 is disposed on the rear end 16. The residue management system 14 is therefore positioned in an area beneath the rear bumper 18, and in front of the unloading ramp 20. One or more harvesting units 22 are located on a front end 24 of the vehicle 12. An operator cabin 26 is also located at the front end 24 of the vehicle 12, generally above the harvesting units 22, thereby providing a substantially unobstructed view of the harvesting operation. As an operator drives the harvesting vehicle 12 in the direction of travel 17, the harvesting units 22 separate agricultural product 28 (e.g., cotton) from unharvested plants 30 (e.g., crops). The harvesting units 22 may include a stripper, picker, thresher, or a combination thereof The agricultural product 28 is transferred to a storage compartment 32 of the vehicle 12. For example, agricultural product 28 may flow into the storage compartment through tube 33. In some embodiments, a storage compartment 32 may include an on-board system to compact or otherwise process the agricultural product 28. This system may operate to build a tightly pressed stack (e.g., a module) of the agricultural product 28 as the product 28 is harvested. The module may be compact and relatively structurally stable, and of a generally rectangular shape, thereby enabling the module to be unloaded, left in the field for storage, then handled (e.g., loaded onto a vehicle designed for transportation) and transported to a processing facility (e.g., a cotton gin).

As illustrated in FIG. 1, after the harvesting units 22 collect the agricultural product 28 from the unharvested plants 30, the harvested plants 36 (e.g., agricultural residue) remain in the field. In order for a module 34 to be successfully unloaded onto the field without interference from the harvested plants 36, it may be desirable to manage the agricultural residue 36 to create a smooth surface. For example, it may be beneficial to create an area where the ground is substantially clear of large debris and vertically oriented stalks. This area may be referred to as a pad 40. Accordingly, during the harvesting process, the operator may receive an indication that the storage compartment 32 is at or nearing capacity and/or a module 34 of agricultural product 28 is at or near completion. Upon receiving the indication, the operator may create the pad 40 onto which a completed module 34 may be deposited. Thus, the operator may lower the residue management system 14 into the illustrated operational position. When in the lowered operational position, the residue management system 14 manages the agricultural residue 36 to create a suitable pad 40. For example, the residue management system 14 may chop and/or shred the agricultural residue 36, as discussed below. Once a pad 40 of an appropriate size is created, the operator may reverse the harvesting vehicle 12 in a direction 41 until the far end of the pad 40 is reached. The operator may then lower the unloading ramp 20, and the substantially complete module may then be unloaded from the storage compartment 32 onto the pad 40. During the pad building operation, the harvesting units may be in a raised transport position, and the residue management system may be in a lowered operational position. After the pad building operation is complete, the harvesting vehicle 12 may move in the direction of travel 17 with the harvesting units 22 in a lowered operational position to harvest the agricultural product 28 from the crops 30 in the field. In addition, the residue management system 14 may be in a raised transport position, leaving harvested but unmanaged stalks 36 in the trail of the vehicle 12. While cotton is discussed herein, the agricultural product 28 may include other suitable crops.

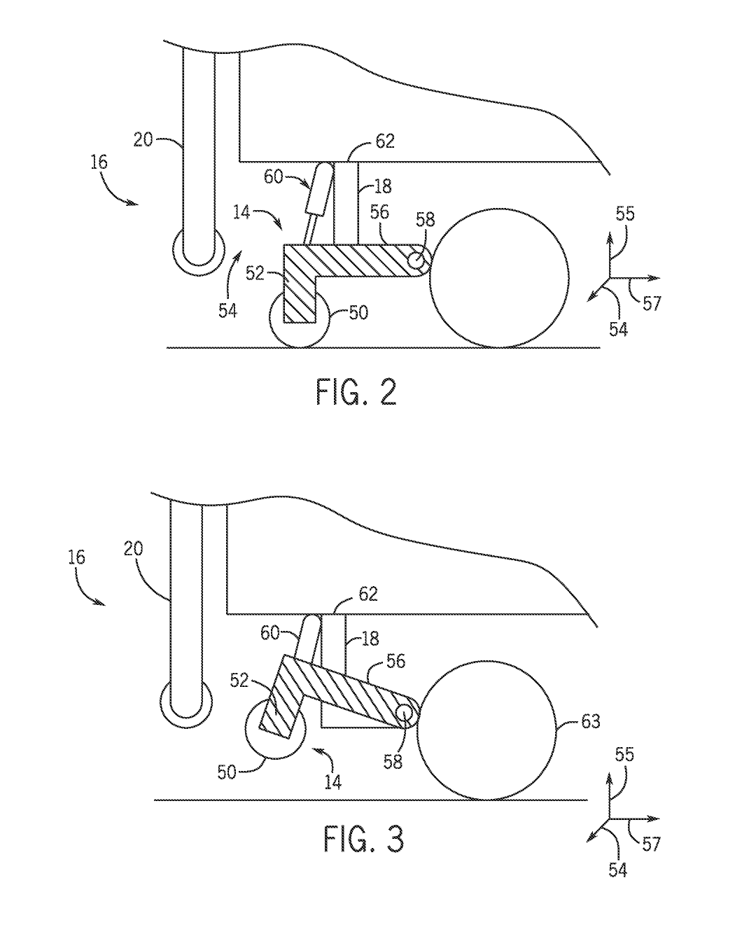

FIG. 2 is a side view of an embodiment of the residue management system 14 of FIG. 1 in a lowered operational position. The system 14 includes a managing assembly 50 supported by a support frame 52 that extends laterally (along a lateral axis 54) across the rear end 16 of the agricultural harvesting vehicle 12. The support frame 52 extends along a vertical axis 55 and is coupled to support arms 56 that extend along a longitudinal axis 57. The supports arms 56 are attached to the rear bumper 18 of the vehicle 12 by a pivot joint 58 that creates a point about which the residue management system 14 may rotate. The system 14 is additionally supported by one or more actuating cylinders 60 that provide linear force to enable the residue management system 14 to be lowered or raised. The actuating cylinders 60 (e.g., hydraulic cylinders, pneumatic cylinders, etc.) may be controlled by the operator via controls located in the operator cabin 26. As illustrated, cylinders 60 couple the support frame to an upper area 62 on the rear bumper 18 that is positioned proximate to and underneath the storage compartment 32. As discussed above, an operator of the system 10 may receive an indication that a module of agricultural product 28 is at or near completion. The operator may then instruct the cylinders 60 to extend, thereby driving the managing assembly 50 into contact with the ground. With the residue management system 14 in the lowered operational position, movement of the vehicle 12 drives the managing assembly 50 to form a pad 40 for deposition of the module on the ground. Alternatively, the operator may deploy the residue management system 14 for reasons other than to build a module pad 40. For example, it may be desirable to process agricultural residue 36 during the harvesting process to prepare the field for a subsequent planting operation.

In some embodiments, the system 10 may include sensors that facilitate automation of the pad building process and/or assist the operator in manually completing the pad-building process. For example, the system may include sensors configured to monitor the size of the area being processed by the residue management system 14. The sensors may be activated when the operator engages the managing assemblies 50. As discussed above, engaging the managing assemblies 50 may be initiated by controls within the cabin 26, prompting the cylinder 60 to extend, thus rotating the managing assembly 50 about the lateral axis 54 to reach an operational position in contact with or proximate to the ground. The sensor may include GPS sensors or systems that monitor the speed of the vehicle when the residue management system 14 is operational. Regardless of the method used, the system may calculate the size of the area that has been managed and indicate to the operator when a pad 40 of the desired size has been created.

FIG. 3 is a side view of an embodiment of the residue management system 14 of FIG. 1 in a raised transport position. As shown, the cylinder 60 supports the system 14 so that it is raised above the ground, and is not operating to manage the agricultural residue on the field. Retraction of the cylinder 60 exerts upward force on the system 14 so that it pivots about the lateral axis 54/pivot joint 58 in an upward direction. This motion raises the managing assembly 50 a distance above the ground so that the managing assembly 50 is not engaged with the ground or agricultural residue 36 on the ground. As discussed above, in some embodiments, it may be desirable to maintain the residue management system 14 in a transport position during various times during the harvesting process. In embodiments where the managing element 50 is powered, when transitioned to the transport position, the rotation of the managing element 50 is stopped.

The cylinders 60 of the present embodiment may be double acting hydraulic cylinders that accept pressurized fluid on two ends, or single acting hydraulic cylinders that accept fluid on only one end. As discussed above, the operator of the system 10 may have access to controls in the operator cabin that enable the operator to place the residue management system 14 in an operational or transport position. Specifically, the operator may actuate the cylinders 60 to generate an upward or downward force on the support frame 52 of the residue management system 14. The system 14, accordingly, pivots upwardly or downwardly about the lateral axis 54, placing the managing assembly 50 into the desired position. For example, extension of the cylinder 60 drives the assembly 50 into the lowered operational position. In other embodiments, the managing assemblies 50 may be driven to rotate by other actuators (e.g., pneumatic, electromechanical, etc.). Because mounting space behind the rear wheels 63 of the vehicle may be limited, telescoping cylinders may be used. For embodiments in which the managing assemblies 50 are powered, rotation may be automatically engaged when the assemblies 50 are placed into the lowered operational position. Alternatively, the operator may be able to selectively provide power to rotate the assemblies 50.

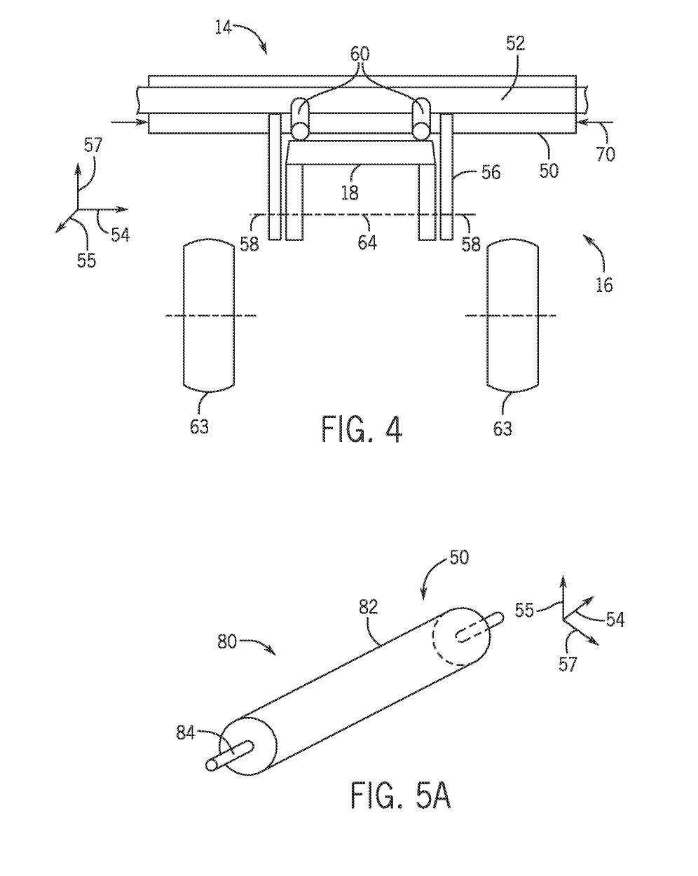

FIG. 4 is a top view of an embodiment of the residue management system 14 of FIG. 2 in a lowered operational position. To illustrate the relative location of the residue management system 14 on the vehicle 12, rear wheels 63 and the rear bumper 18 of the vehicle 12 are included for reference. As shown, the managing assembly 50 extends laterally across the rear end 16 of the vehicle 12 in the direction 54. In the present embodiment, the width 70 of the managing assembly 50 is generally equal to the width of four wide rows or five narrow rows of crops 30, or approximately 3.5 meters. This width 70 is selected to create a pad 40 of adequate width for the module 34, which is created within the storage compartment 32 of the harvesting vehicle 12. Thus, the managing assembly 50 may be at least as wide as the storage compartment 32. In other embodiments, the width 70 of the managing assembly 50 may be greater than the width of the storage compartment. For example, the width 70 may be about 4 meters, 4.5 meters, 5 meters, or any other suitable width. A greater width 70 may be desired to facilitate creation of a larger pad 40, or to enable efficient management of a field for other subsequent uses. For example, the width 70 of the managing assembly 50 may be substantially equal to the total width of the harvesting units 22.

As illustrated, the support frame 52 is positioned above the managing assembly 50. The support arms 56 extend forwardly along the longitudinal axis 57 from the support frame to the rear bumper. As described above, the support arms 56 are coupled to the bumper 18 at a pivot joint 58. As shown, there is one pivot joint on each of two sides of the rear bumper 18. A rotational axis 64 extending through the two pivot joints 58 defines an axis about which the residue management system 14 may pivot. As the system 14 pivots about the axis 64, the managing assembly 50 is lowered into the operational position where it engages with the ground and agricultural residue 36, as shown in FIG. 2. The managing assembly 50 may also be raised into the transport position, as shown in FIG. 3.

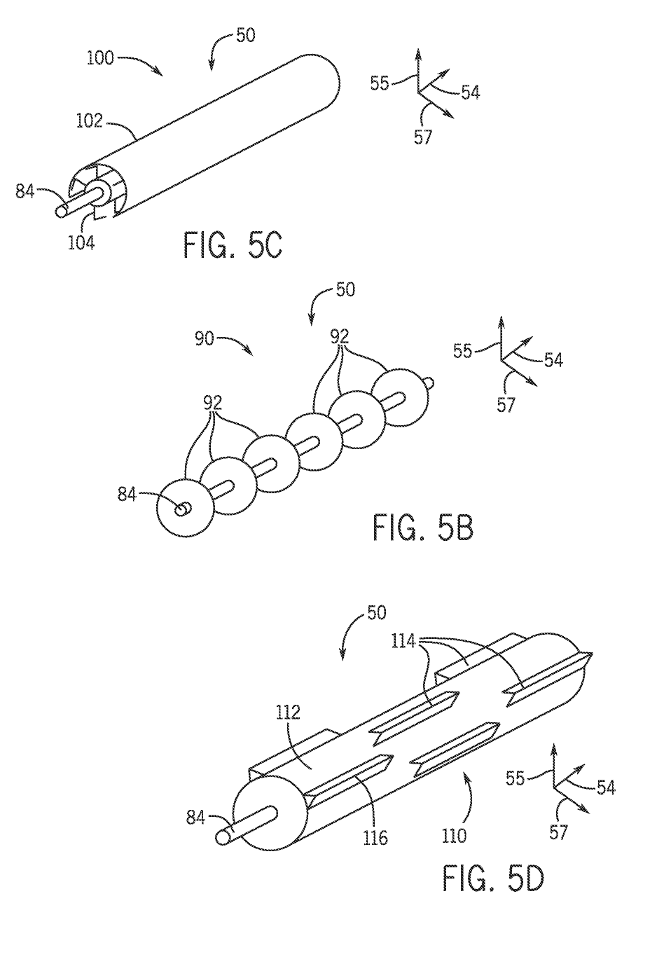

FIGS. 5A-5D are perspective views of respective embodiments of managing assemblies 50 of the residue management system 14 of FIG. 2. The managing assembly 50 may operate by engaging the ground when the residue management system 14 is placed in the lowered operational position, as shown in FIG. 2. Additionally, in some embodiments, the managing assembly 50 may be driven to rotate (e.g., by the harvesting vehicle engine). FIG. 5A is a perspective view of an embodiment of a smooth roller 80 that includes a cylindrical body 82 and a shaft 84. The shaft 84 is coupled to the frame 52 and configured to rotate about the lateral axis 54. The cylindrical body 82 is generally formed from a heavy or weighted material in order to effectively compact and flatten agricultural residue. The material may include thick steel, a thinner steel filled with concrete, or a cylinder filled with water. The weight of the cylindrical body 82 causes it to rotate forwardly or backwardly based on the movement of the vehicle 12.

FIG. 5B is a perspective view of an embodiment of a disc harrow 90 managing assembly 50. The disc harrow 90 includes multiple disc blades 92 arranged on a shaft 84. The shaft 84 is coupled to the frame 52 and configured to rotate about the lateral axis 54. The disc blades 92 may independently rotate about the shaft 84, and individually engage the ground and agricultural residue 36. Alternatively, the disc blades 92 may be fixed to the shaft so that they rotate with the shaft 84. The disc blades 92 may be arranged substantially vertical and substantially parallel to one another. In some embodiments, the disc blades 92 may be arranged at various angles relative to the direction of travel 17 to enable the discs 92 to move processed agricultural residue 38 in opposite lateral directions as the discs 92 rotate along the ground.

FIG. 5C is a perspective view of an embodiment of a flail cutter 100 including a sheath 102 surrounding blades 104 positioned on an inner shaft 84. As with the disc harrow, the blades 104 may be free to rotate individually, or they may be fixed to the shaft 104. The flail cutter 100 managing assembly 50 is powered (e.g., to rotate by the harvesting vehicle engine).

FIG. 5D is a perspective view of an embodiment of a managing assembly 50 having a ribbed roller 110 with a cylindrical body 112 and multiple ribs 114 extending along an outer surface of the cylindrical body. As pictured, the ribs 114 have an edge 116 defining a triangular cross section, but in some embodiments the ribs may have two or more edges 116 that define cross sections of different shapes. In other embodiments, the managing assembly 50 may include other devices having a rotating member that rotates about the lateral axis.

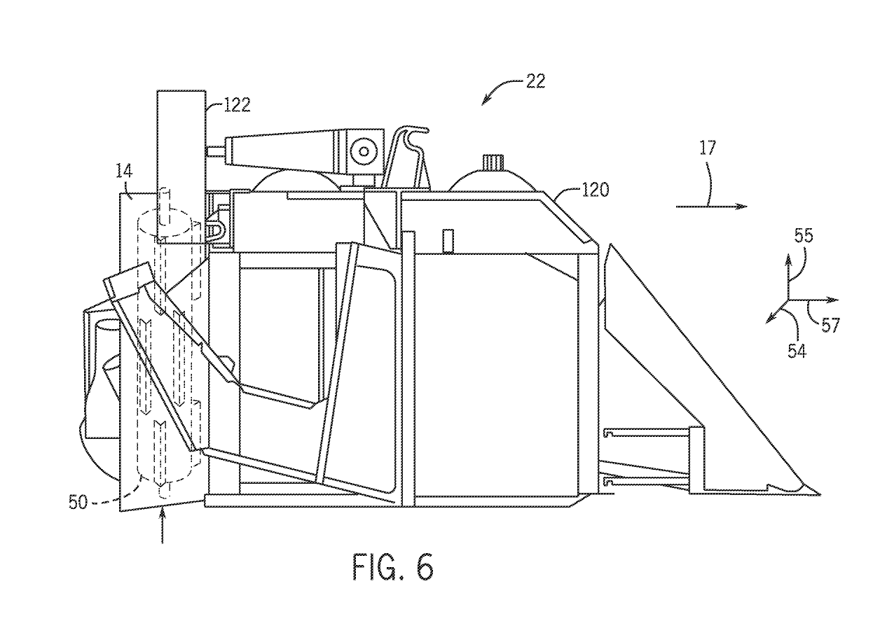

FIG. 6 is a side view of an embodiment of a harvesting unit 22 of a harvesting vehicle 12 with a residue management system 14. The harvesting element 22 includes a drum 120 (e.g., picking head), which is coupled to the front end 24 of the harvesting vehicle 12 by means of a drum toolbar 122. The residue management system 14 is also coupled to the same toolbar 122 and is positioned behind the drum 120. The managing element is oriented vertically and rotates about the vertical axis 55. The residue management system operates with the drum to manage residue concurrently with the harvesting process. In some embodiments, the residue management system 14 is configured to fit within the drum housing. In other embodiments, the residue management system 14 is coupled to the drum 120 in a separate housing. The coupling of the system 14 to the drum 120 enables the system 14 to move vertically with the drum 120 along the vertical axis 55 (e.g., when raising and lowering the toolbar). The residue management system 14 may be powered by the same source as the drum 120, or may be powered by a separate power source.

FIG. 7 is a top view of an embodiment of a harvesting element 22 of a harvesting vehicle 12 with an embodiment of a residue management system 14. As discussed above, the residue management system 14 may be coupled to the same toolbar 122 as the drums 120. In other embodiments, each residue management system 14 may be included within the housing of a respective drum 120. As shown, the residue management system is mounted in a vertical orientation behind picking rotors 123 and 124 of the drum 120. Additionally, the residue management system 14 is installed within the drum 120 directly behind a rear picking rotor 124 relative to the direction of travel 17. Positioning of the residue management system 14 behind a picking rotor 124 enables the drum drive train to be utilized to power the residue management system 14. Because each drum 120 includes a corresponding residue management system 50, a full width of the harvesting swath is covered by the residue management systems 14.

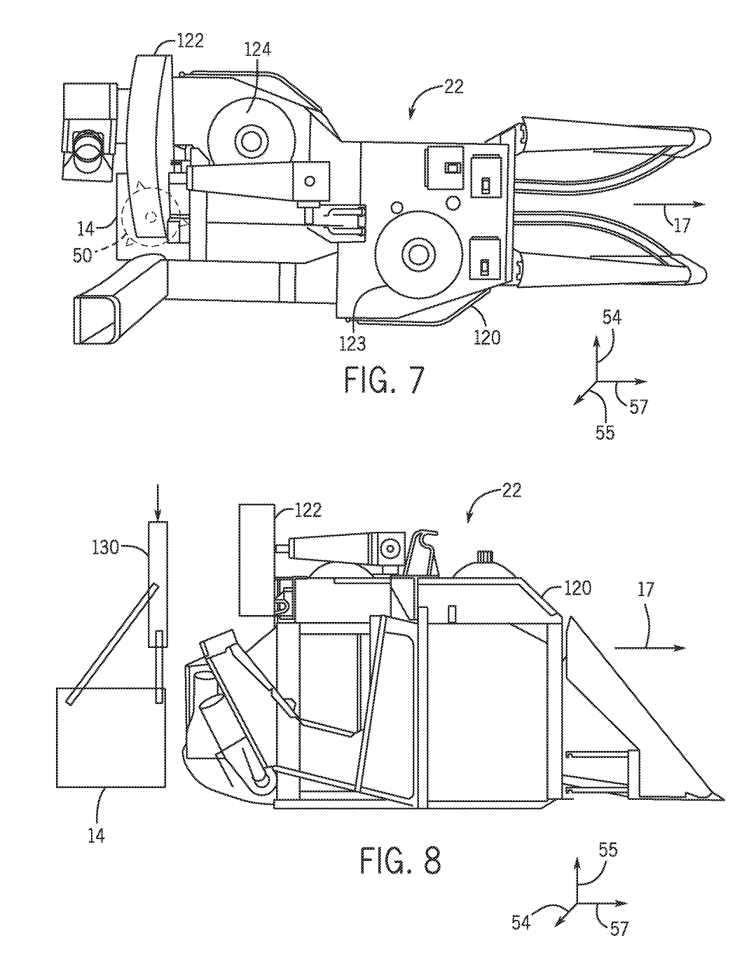

FIG. 8 is a side view of an embodiment of a residue management system 14 installed on a second toolbar 130 proximate to the front end 24 of the harvesting vehicle 12. The use of a second toolbar enables the operator to independently adjust the height of the residue management system 50 relative to the drums. This option enables the operator to selectively leave residue unmanaged (e.g. to conserve power). In yet other embodiments, the residue management functions may be engaged or disengaged on a per row (e.g., per drum 120) basis. For example, an individual residue management system 14 may be associated with each drum 120. Because there is a drum for each row of crop 30 being harvested, the individual residue management systems 14 enable the operator to select individual rows to undergo residue management, while enabling others to remain unmanaged. This option also enables the operator to manage the allocation of power, thereby prioritizing functions of the harvesting and residue management systems. For example, the operator may disengage the outermost residue management systems 14 and allocate power to only the systems 14 sufficient to build a pad 40. At other times, the operator may decide to engage all of the residue management systems 14 and process the agricultural residue 36 of each row of crop 30 being harvested. Optionally, management systems 50 may be installed on both the front end 24 and the rear end 16 of the vehicle. Alternatively, part of the residue management system 50 may be located proximate to the front end 24 and part proximate to the rear end 16 of the vehicle 12.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A residue management system for an agricultural vehicle, comprising:
a managing assembly configured to manage agricultural residue, wherein the managing assembly comprises a rotating member configured to rotate about a shaft that extends along a lateral axis of the agricultural vehicle relative to the direction of travel;
a frame configured to support the managing assembly; and
a support arm coupled to the frame and configured to pivotally couple to a support structure of the agricultural vehicle proximate to a rear end of the agricultural vehicle relative to the direction of travel, wherein the support arm is configured to facilitate movement of the managing assembly between a lowered operational position and a raised transport position.

2. The system of claim 1, wherein the support structure comprises a rear bumper of the agricultural vehicle.

3. The system of claim 1, comprising an actuating cylinder coupled to the support arm and configured to drive the managing assembly between the lowered and raised positions.

4. The system of claim 1, wherein the support arm comprises a joint structure configured to enable the support arm to pivot about a pivot axis relative to the support structure.

5. The system of claim 1, wherein the rotating member comprises a substantially smooth roller, a roller with ribs, a flail cutter, a disc harrow, or a combination thereof.

6. The system of claim 5, wherein the rotating member is driven to rotate by contact with the ground.

7. The system of claim 5, wherein the rotating member is configured to be driven in rotation by a power source.

8. The system of claim 1, wherein the agricultural vehicle is a module-building cotton harvester.

9. A residue management system for an agricultural vehicle, comprising:
a managing assembly disposed on a toolbar proximate to a first end of the agricultural vehicle, wherein the toolbar is configured to support a harvesting element, the managing assembly is configured to manage agricultural residue, and the managing assembly comprises a vertical rotating member configured to rotate about a shaft that extends along a vertical axis.

10. The system of claim 9, wherein the managing assembly is configured to be disposed behind the harvesting element.

11. The system of claim 10, wherein the managing assembly comprises a housing independent of the harvesting element.

12. The system of claim 9, wherein the managing assembly is configured to be disposed within a housing of the harvesting element behind a picking rotor.

13. The system of claim 9, wherein the rotating member comprises a substantially smooth roller, a roller with ribs, a flail cutter, a disc harrow, or a combination thereof.

14. The system of claim 9, wherein the rotating member is configured to be driven in rotation by a power source.

15. The system of claim 1, wherein the agricultural vehicle is a module-building cotton harvester.

16. An agricultural vehicle, comprising:
a harvesting element coupled to a first toolbar proximate to a front end of the agricultural vehicle; and
a residue management system having a managing assembly disposed on a second toolbar positioned behind the first toolbar relative to a direction of travel, wherein the managing assembly is configured to manage agricultural residue.

17. The vehicle of claim 16, wherein the managing assembly comprises a vertical rotating member configured to rotate about a shaft that extends along a vertical axis.

18. The vehicle of claim 17, wherein the rotating member comprises a substantially smooth roller, a roller with ribs, a flail cutter, a disc harrow, or a combination thereof.

19. The vehicle of claim 17, wherein the rotating member is configured to be driven in rotation by a power source.

20. The vehicle of claim 16, wherein the agricultural vehicle is a module building cotton harvester.
